(19) United States
(12) Patent Application Publication
(10) Pub. No.: US 2020/0028776 A1
(43) Pub. Date: Jan. 23, 2020

(54) SYSTEM AND METHOD FOR A TRANSLATOR SUPPORTING MULTIPLE SOFTWARE DEFINED NETWORK (SDN) APPLICATION PROGRAMMING INTERFACES (APIs)

(71) Applicant: NETSIA, INC., Sunnyvale, CA (US)

(72) Inventors: ALI VOLKAN ATLI, ISTANBUL (TR); ISMAIL BAYRAKTAR, ISTANBUL (TR); CAN ALTAY, ISTANBUL (TR); SEYHAN CIVANLAR, ISTANBUL (TR); MAHIR GUNYEL, ISTANBUL (TR); ERHAN LOKMAN, ISTANBUL (TR)

(21) Appl. No.: 16/041,727

(22) Filed: Jul. 20, 2018

(51) Int. Cl. H04L 12/721; H04L 12/715; H04L 12/947; H04L 12/931; G06F 9/54

(52) U.S. Cl. CPC H04L 45/38; H04L 45/64; G06F 9/547; H04L 49/70; H04L 49/252

(57) ABSTRACT

A programmable switch for use in a Software Defined Network (SDN) is disclosed that supports multiple open Application Programming Interfaces (APIs) between the switch and various types of controllers, where each such API supports a different function set and possibly uses different IP protocols such as Transmission Control Protocol (TCP) and User Datagram Protocol (UDP).

### BACKGROUND OF THE INVENTION

### Field of Invention

The subject matter disclosed herein relates generally to wireline and wireless communications networks, and more particularly to a system and method for a translator supporting multiple Software Defined Network (SDN) Application Programming Interfaces (APIs).

### Discussion of Related Art

The need for a new type of switch is obvious because of a plurality of SDN architectures that have been emerging in the telecommunications infrastructures to support wired and wireless networks in data centers, LANs, WANs and now in cellular network's core infrastructure. Currently, the most popular SDN API is OpenFlow, which is designed to support fixed-function ASICs (optimally designed for packet forwarding) that are only programmed using that ASIC vendor's proprietary interface. OpenFlow has been continuously evolving to support more and more features. Meanwhile, a run-time programming paradigm called P4 has been emerging to directly program new types of directly-programmable ASICs. In parallel, 3GPP has been defining a new API for its core network based on SDN, but that API is different than OpenFlow.

Manufacturing a different switch for each of these networking applications is the only mechanism provided for in the prior art. However, in all of these networking scenarios, whether the ASIC is fixed-function with a proprietary interface or directly-programmable, the switch acts as a forwarding device optimized for fast packet switching while the controller is where routing decisions are being made.

What is needed is a programmable generic switch with a ‘translator’ layer supporting various APIs seamlessly.

Embodiments of the present invention are an improvement over prior art systems and methods.

### SUMMARY OF THE INVENTION

In one embodiment, the present invention provides a method as implemented in a network switch within a software defined network (SDN), the method comprising: (a) receiving, from a controller in the SDN, a request to attach and control the network switch over a specific SDN protocol type among one or more SDN protocol types, the network switch supporting the one or more SDN protocol types, the network switch having a switching component having an associated programming language, the network switch storing, for a given SDN protocol type: (1) an agent application, (2) an application programming interface (API), and (3) information in the agent application for communicating with the controller via the given SDN protocol type; (b) activating a specific agent application corresponding to the specific SDN protocol type specified by the request; (c) receiving one or more messages from the controller; (d) translating messages received in (c) using the activated specific agent application from the specific SDN protocol type to the programming language associated with the switching component of the network switch; and (e) programming the switching component according to translated messages in (d).

In another embodiment, the present invention provides a network switch within a software defined network (SDN), the network switch comprising: at least one network interface card (NIC); a memory; a central processing unit (CPU) linked to the NIC and the memory, and wherein the network switch: (a) receiving, from a controller in the SDN, a request to attach and control the network switch over a specific SDN protocol type among one or more SDN protocol types, the network switch supporting the one or more SDN protocol types, the network switch having a switching component having an associated programming language, the network switch storing in the memory, for a given SDN protocol type: (1) an agent application, (2) an application programming interface (API), and (3) information in the agent application for communicating with the controller via the given SDN protocol type; (b) activating a specific agent application corresponding to the specific SDN protocol type specified by the request; (c) receiving one or more messages over the NIC from the controller; (d) translating messages received in (c) using the activated specific agent application from the specific SDN protocol type to the programming language associated with the switching component of the network switch; and (e) programming the switching component according to translated messages in (d).

In yet another embodiment, the present invention provides an article of manufacture comprising non-transitory computer storage medium storing computer readable program code which, when executed by a processor implements a method as implemented in a network switch within a software defined network (SDN), the computer storage medium comprising: (a) computer readable program code receiving, from a controller in the SDN, a request to attach and control the network switch over a specific SDN protocol type among one or more SDN protocol types, the network switch supporting the one or more SDN protocol types, the network switch having a switching component having an associated programming language, the network switch storing, for a given SDN protocol type: (1) an agent application, (2) an application programming interface (API), and (3) information in the agent application for communicating with the controller via the given SDN protocol type; (b) computer readable program code activating a specific agent application corresponding to the specific SDN protocol type specified by the request; (c) computer readable program code receiving one or more messages from the controller; (d) computer readable program code translating messages received in (c) using the activated specific agent application from the specific SDN protocol type to the programming language associated with the switching component of the network switch; and (e) computer readable program code programming the switching component according to translated messages in (d).

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates traditional router/switch architecture.

FIG. 2 illustrates a programmable switch according to prior art.

FIG. 3 illustrates an OpenFlow switch according to prior art.

FIG. 4 illustrates a generic P4 switch according to prior art.

FIG. 5 illustrates one embodiment of the switch architecture and components according to this invention.

FIG. 6 illustrates the embodiment of a translator external to a generic switch.

FIG. 7 illustrates the embodiment of the translator according to this invention specific to P4 switch.

FIG. 8A and FIG. 8B illustrate exemplary message sequences.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device (e.g., a network switch or controller) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, router, or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers. An Application Specific Integrated Circuit (ASIC) is a microchip custom designed and optimized for a specific application such as packet forwarding. These chips are widely used for specific devices such as routers or switches. The manufacturer of the ASIC provides a simple programming language, such as Hardware Description Language (HDL), to program the ASIC. However, ASICs are not re-programmable for different application types.

Before going into the specifics of programmable networks, it is important to address the relationship between the control plane and the data plane, and how programmable networks change this relationship. One of the key attributes of programmable networks is the “separation” of the control plane from the data plane. This is achieved by converting the traditional router into a hardware-based fast packet forwarding gear (the data plane), and delegating the routing decision to a CPU that is called the ‘controller’ completely separated from the forwarding gear (the control plane).

In a typical router, the controlling element (Central Processing Unit, CPU) and the forwarding element, the hardware switch (Application Specific Integrated Circuit, ASIC), are within the same box. The ASIC is called ‘fixed-function’ because it is specially designed, for example, for IP packet forwarding, meaning it is responsible for receiving packets from one port, processing them according to predefined actions (dropping, forwarding, buffering, etc.), and then forwarding them back out from another port. This is essentially described as the main function of the data plane. Many router companies are using ‘generic’ packet-forwarding ASICs (such as the Broadcom Trident chipset), although many switch manufacturers still prefer to make their own chipset to have customized features. Note that these chips are fixed-function and not directly programmable.

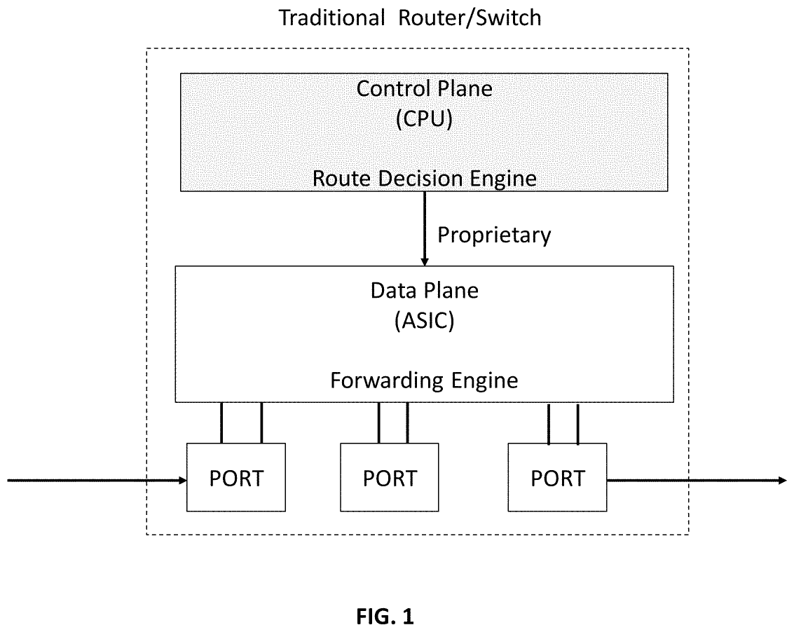

The data plane doesn't make decisions about how to forward traffic. It receives those decisions from the control plane. The control plane is typically a collection of software local to a router that programs flows (rules that identify a traffic flow and decide what to do with it) into the data plane, so the data plane knows how to perform packet forwarding. This is performed by programming ‘flow-tables’ into the ASIC. As illustrated in FIG. 1, the control plane interacts directly with the data plane to implement these flows in the hardware. The “language” used to program these flows greatly varies based on the hardware vendor. Each ASIC has its own flow-table programming language that is private to that vendor. So far, a generic programming language all fixed-function ASICs hasn't been published, though among popular languages is Verilog.

When one router receives reachability information for a network via a routing protocol such as OSPF or BGP, it then programs its own data plane so that packets are properly routed. Basically, the routers make forwarding decisions using resident routing software within its own CPU, but using open routing protocols to communicate with neighbor routers in the network. This is one of the key functions of the control plane.

The industry decided that it would be useful to define a standardized configuration API for a controller so that the common forwarding information can be programmed into the switches easily. OpenFlow should be thought of as an attempt at that standardized API—a simple programmatic interface that can be used by all vendors. However, while there are other APIs like NETCONF, primarily focused on the configuration of the router, OpenFlow intends to provide access to the data plane/hardware. OpenFlow does this by specifying a protocol that a switch can instantly recognize and translate its messages into the programming language of the fixed-function ASIC within the switch and program it accordingly. The rules within OpenFlow messages are programmed as match-action entries in flow-tables within the ASIC.

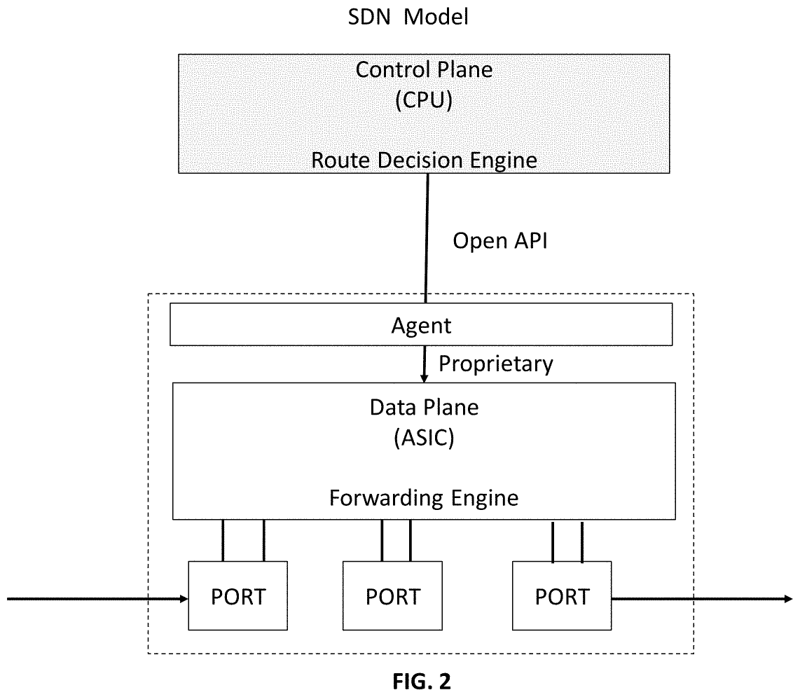

OpenFlow is not intended to program flows into hardware directly. Instead, OpenFlow provides a way to describe the desired flow processing rules to an ‘agent’ running locally on the switch. As illustrated in FIG. 2, this ‘agent’, armed with the flow rules programmed into it by a remote controller, acts like a local ‘virtual’ control plane. Unlike the control plane in FIG. 1, it doesn't run any routing protocols, or make decisions locally—the controller, that is remote, performs all these functions using a CPU. So, the local ‘agent’ must only store these OpenFlow entries, and then push them into the vendor-specific ASIC. Since routing decisions are not performed locally, the term ‘switch’, ‘forwarder’ or ‘forwarding device’ is used for the data plane devices as opposed to ‘router’ wherein routing decision is local.

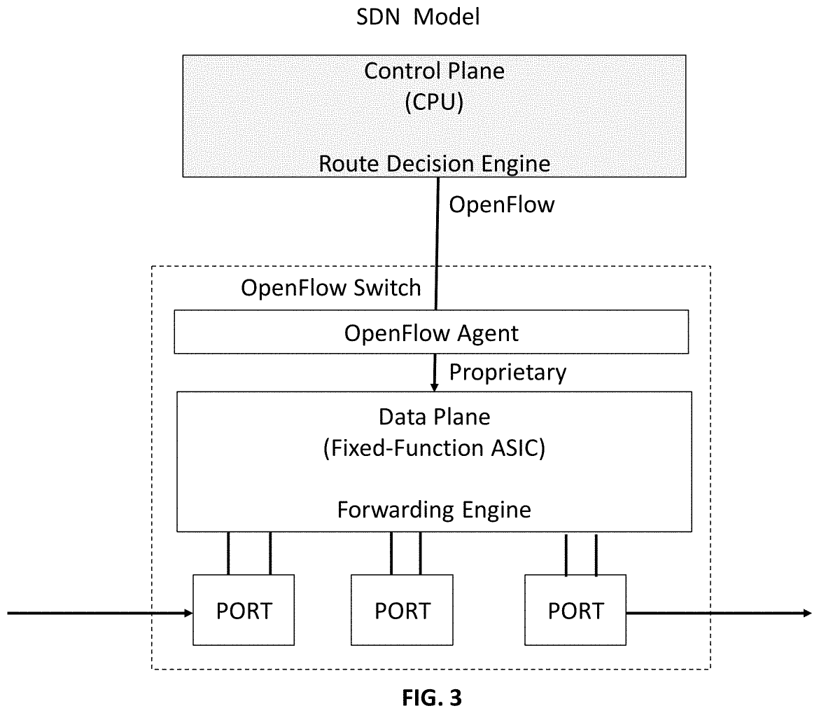

FIG. 3 illustrates how these concepts are realized using the OpenFlow Switch specification (see 3GPP OpenFlow Switch Specification version 1.5.0 document as a reference). OpenFlow evolved over the past years from implementing simple to highly complicated rules and constructing flow tables by inspecting many different packet header fields. Multiple types of flow tables (such as Group Tables) evolved over time. However, OpenFlow couldn't change the paradigm of proprietary interfaces into the hardware as the backend. As a side note, we should also mention that the industry is also using Field Programmable Gate Arrays (FPGA)s as an alternative to ASICs although in a smaller scale, and software switches such as Open vSwitch (OVS) in some applications. OVS is comprised of a software-based virtual switching fabric (vSwitch) and virtual ports (vPort) on a purely software based SDN switch implementations. FPGA is a type of hardware that is reprogrammable.

In the past, programmable switch chips such as Network Processing Units (NPUs) could only process packets at about one-tenth or one-hundredth the rate of fixed-function

ASICs. But today, there are reconfigurable switch chips that can process packets just as fast as fixed-function ASICs. We called this type of programmable chip a “PISA” chip (Protocol Independent Switch Architecture). PISA chips can open up a new era in networking in which we can define exactly how packets are processed in the switches. P4, Programming Protocol-Independent Packet Processor, developed by P4 Org is a recent attempt to define a programming language to directly program a PISA chip. The controller basically generates a ‘P4 program’. When loaded onto the switch (so called the P4 switch), a P4 compiler generates the target P4 code and generates directly the flow-tables on the hardware (see P4 org documentation). The P4 switch doesn't need the ‘Agent’ because the P4 compiler on the switch takes the P4 program, parses it and generates the flow tables and packet buffers according to the program directly on the programmable ASIC. This new paradigm allows a highly flexible switch implementation with a wider array of rule sets for packet processing than using the fixed-function ASICs.

Concurrent to the P4 effort, 3GPP has been developing new core network architecture for 5G based on SDN and Network Function Virtualization (NFV) by cloudifying all core network functions using a so called ‘service model’, and by splitting the control and data planes and widely distributing functionality across the network. For example, the serving gateway (SGW) and packet gateway (PGW) functions of the 4G Core Network are now separated into control plane (CP) and user plane (UP) functions with a Control and User Plane Separation (CUPS) interface in between that is being defined by 3GPP. For example, control plane functions are grouped as Service Management Function (SMF) while data plane functions are grouped as User Plane Function (UPF) with the N4 interface between them (see 3GPP TS 29.244 Rel. 14 for reference).

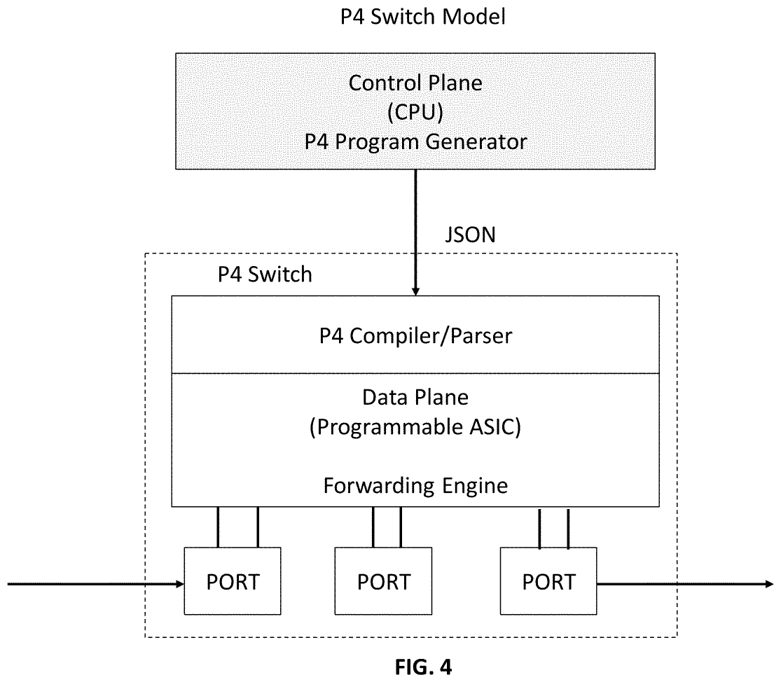

In FIG. 4, a P4 switch is illustrated wherein the P4 program generated by the controller is compiled and parsed in the switch and flow-tables are directly generated on the ASIC without the need for an Agent.

The recent evolution in data networking calls for a different type of highly flexible and multi-purpose switch implementation, which is the topic of this invention. There are at least three switch embodiments of the invention:

1. The first embodiment is a network switch that supports a plurality of SDN protocols towards different types of SDN controllers depending on the networking application, wherein the hardware component of said network switch is a fixed-function ASIC with a proprietary programming interface. A ‘translator’ is deployed within the switch that has a suite of ‘agents’, each agent responsible for translating from one SDN protocol to the proprietary programming interface of the ASIC. Furthermore, the network switch contains an optional ‘agent selector’ function with has a simple interface to any type of SDN controller to allow the controller to declare its ‘type’ and ‘protocol’ it will use on its interface towards the network switch. Said ‘agent selector’ function is also responsible to activate the Agent corresponding to the protocol SDN controller declares. This embodiment is a new type of flexible SDN switch with multiple roles, each role attained by using a different type of controller, each controller operating the switch in a different application/context (e.g., 5G switch, LTE switch, or WAN switch, etc.).

2. The second embodiment is a network switch that supports a plurality of SDN protocols towards different types of SDN controllers, wherein the hardware component of said network switch is a directly programmable ASIC. The switch with a programmable ASIC is called a ‘generic switch’. The generic switch is responsible to compile and parse the program and execute it on the switch hardware. The aforementioned P4 switch is a version of the generic switch using P4 language to program the switch. Other programming languages than P4 may also emerge to compete with P4 over the next decade. The ‘translator’ can be deployed outside the generic switch that has a suite of ‘agents’, each agent being responsible for generating the program to be compiled on the generic switch from a specific SDN protocol. Furthermore, the translator has an optional ‘agent selector’ function with a simple interface to the SDN controller that allows the controller to declare its ‘type’ and the ‘protocol’ it will use on its interface towards the generic switch. Said ‘agent selector’ function is also responsible to activate the Agent corresponding to the protocol SDN controller declares.

3. The third embodiment of the translator may have all agents initially in an active state (for example at specific pre-defined switch ports) to allow a specific type of controller to attach the switch at that port at start-up. In this embodiment, there is no need for the agent selector function. Once the controller attaches to an agent, the switch can automatically deactivate all other active agent types to prevent another type of controller to access the switch.

Kanekar et.al. in U.S. Pat. No. 9,467,536 B1 describes an abstraction layer within an SDN controller to support multiple SDN protocols. However, Kenakar et al. do not teach a network device supporting multiple SDN protocols. It does teach a way an SDN controller can control a group of heterogeneous network devices, each device with a different SDN protocol.

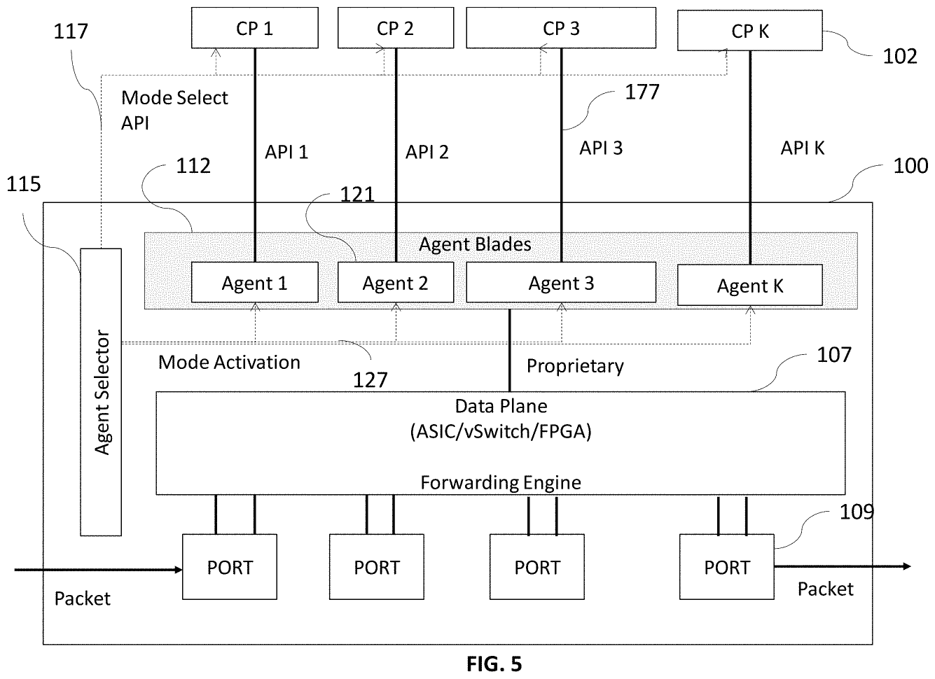

FIG. 5 illustrates the first embodiment of the network switch per this invention with a fixed-function ASIC 107 acting as the packet-forwarding engine. Packet traffic arrive and leave the switch on physical ports 109, traversing ASIC 107 first. Translator 112 is also referred to as the Agent Blades that have different types of agents 121, each agent supporting a different type of SDN protocol (such as OpenFlow, N4, etc.) towards controller 102 representing the control plane (denoted as CP). The controller's southbound interface towards the switch is shown as API 177. One of the controllers 102 attaches to switch 100 by connecting to Agent Selector 115 first. Each controller uses the same interface 117 towards Agent Selector 115. On interface 117, the controller declares its preferred protocol towards the switch. Say CP 3 prefers API 3, in which case Agent

Selector 115 activates Agent 3, using internal messaging interface 127. Agent 3 is responsible for receiving SDN controller's messages in API 3 (or protocol 3) formats and converts them to the fixed-function ASIC 107's proprietary language and program the hardware accordingly. Agent Selector 115 and Agent Blades 112 work together to form the ‘translator’ functions. In this embodiment, the translator is embedded in the switch because its backend is proprietary and ASIC dependent.

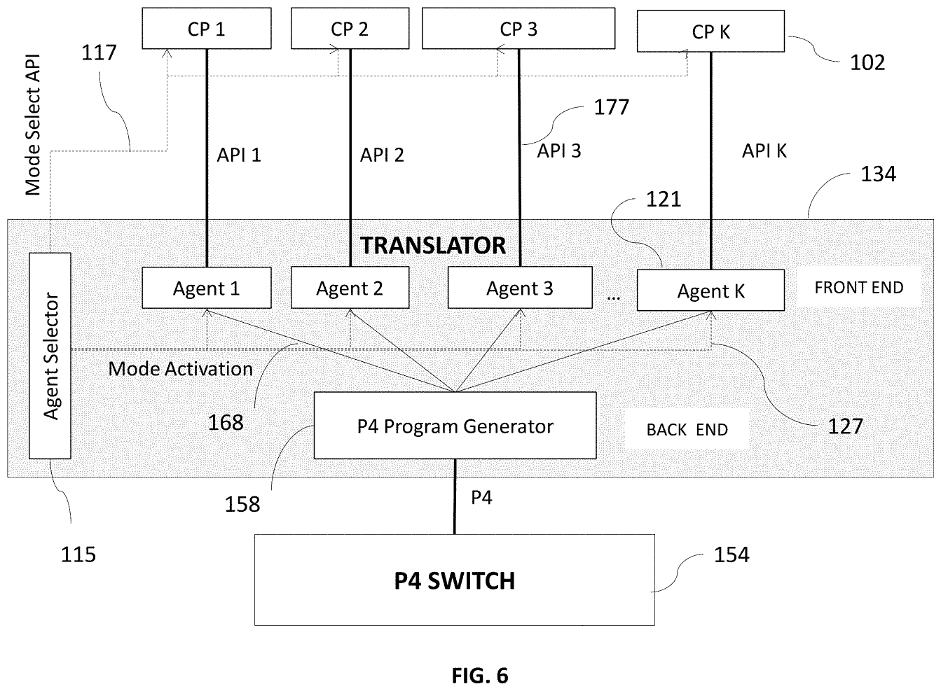

FIG. 6 illustrates the second embodiment per this invention with a directly-programmable generic switch (shown as P4 switch 154). In this embodiment, Translator 134 is an adjunct to generic/P4 switch 154. It has three key functions: Agent Blades 112 that has different types of agents 121, each agent supporting a different SDN protocol (such as OpenFlow, N4, etc.) towards controller 102 representing the control plane (CP). The controller's southbound interface towards the switch is shown as API 177. One of the controllers 102 attaches to switch 100 by connecting to Agent Selector 115 first. Each controller uses the same interface 117 towards the Agent Selector. On interface 117, the controller declares it's preferred protocol towards the switch. Say CP 3 prefers API 3, in which case Agent Selector 115 activates Agent 3, using messaging interface 127. Agent 3 is responsible for receiving SDN controller's messages in API 3 (or protocol 3) formats, stripping the message content and sending the content to generic/P4 program generator 158 using interface 168. Agent Selector 115 and Agent Blades 112 work together to form the translator as a stand-alone component.

Although FIG. 6 illustrates the translator serving a single SDN controller and a single P4 switch, in another embodiment, the translator may be configured to simultaneously serve multiple SDN controllers at the frontend (each controller with the same or different SDN protocol type) and/or multiple P4 switches at the backend. Doing so, few translators may serve a large SDN network. In this embodiment, there may be multiple active agents each supporting the same SDN protocol type and serving a separate switch. Such variations of implementation are trivial and thus covered by this invention.

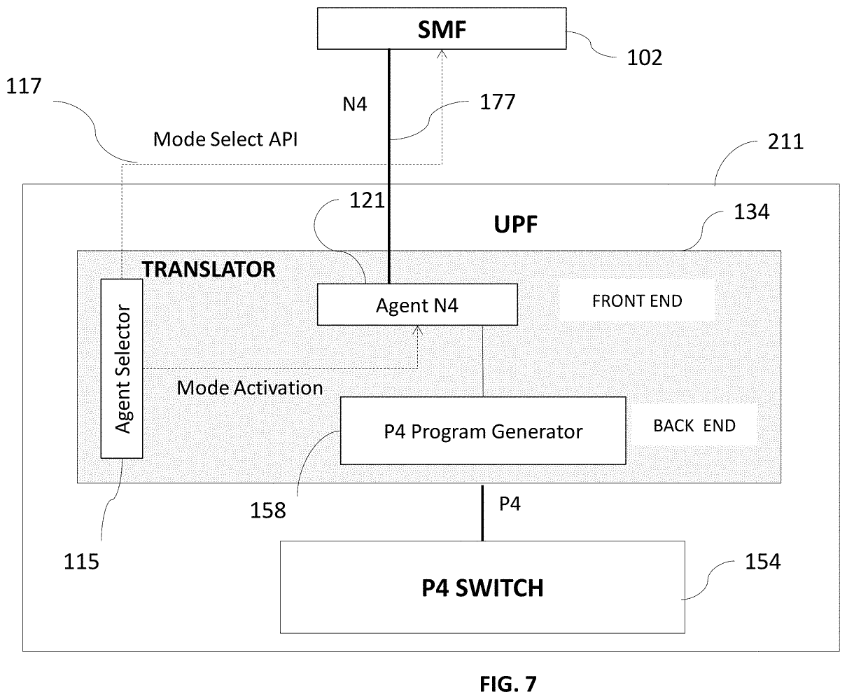

FIG. 7 illustrates a realization of Translator 134 with a P4 switch in a 5G core network to support the SMF and UPF functions. UPF is comprised of Translator 134 and P4 switch 154, and SMF is comprised of controller 102. Agent 121 is the Agent for N4 protocol. When selected by SMF using interface 117, Translator 134 activates only that Agent and translates the received N4 messages to a P4 program using block 158, and loads the program onto P4 switch 154.

Please note that any programmable switch with an open interface would serve as the generic switch. A P4 switch is a version of a generic switch supporting a specific programming paradigm called P4.

The mode select API 117 between Agent Selector 115 and Controller 102 can be implemented as (1) a part of standardized interface 177 between agent 121 and controller 102 or (2) a separate propriety interface which is specially defined for translator 134 (e.g., RESTful API). Let us consider the N4 interface as FIG. 7 illustrates wherein mode select API 117 is implemented as a part of N4 interface 177. In this configuration, control connection establishment and modification messages such as “N4 Association Setup/Update/Release Request/Response” messages are communicated between SMF 102 and Agent Selector 115. The other control messages of N4 interface for tasks such as forwarding rule manipulation, flow prioritization, or reporting are communicated between SMF 102 and Agent N4 121.

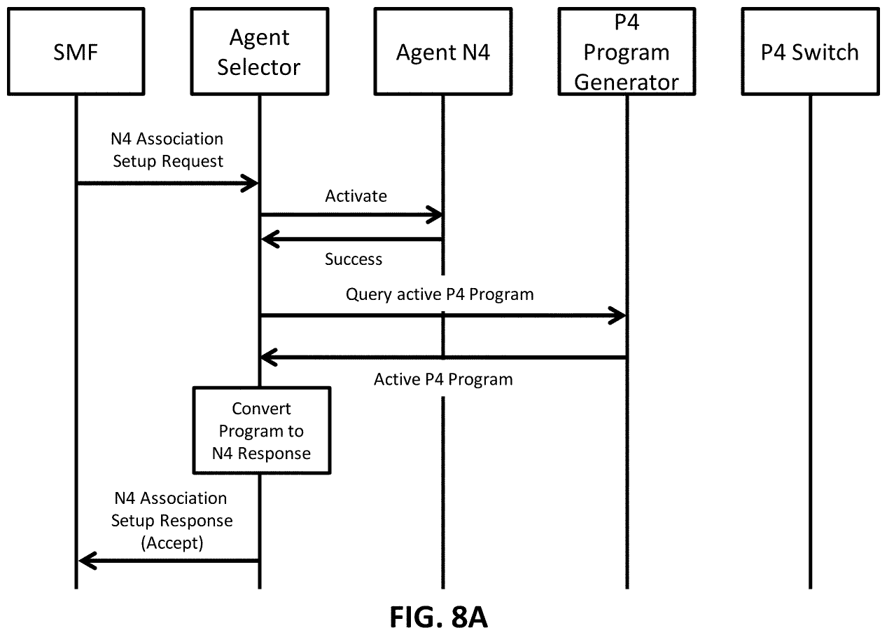

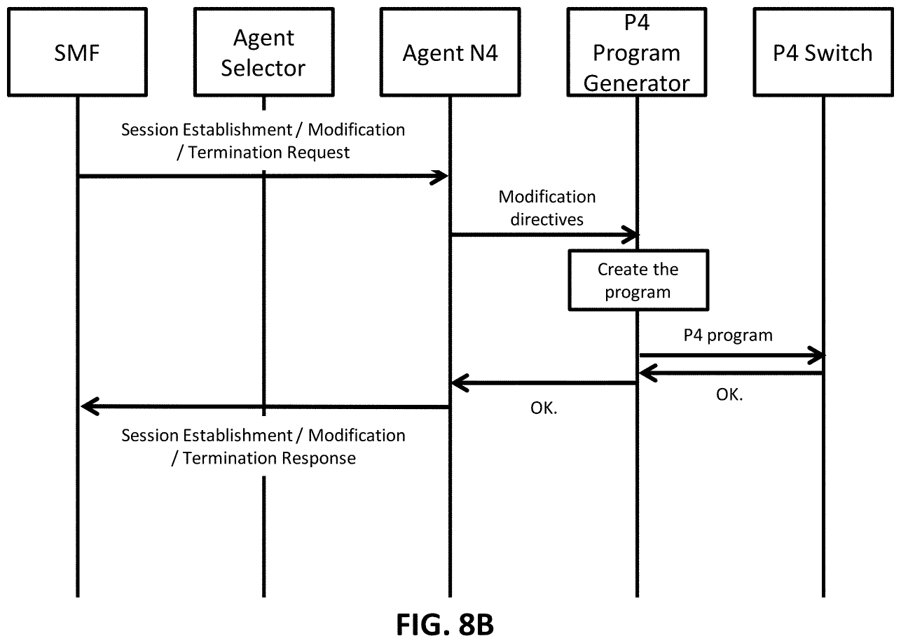

FIG. 8A illustrates a control connection establishment procedure between SMF and Agent N4. SMF initiates the connection with N4 Association Setup Request message which includes SMF node id and its support for optional features. As Agent Selector receives this message, it decides to accept N4 connection and activates its idle Agent N4 unit. Agent Selector may reject N4 association due to (1) a pre-adjusted rejection configuration or (2) an on-going control connection between another agent and controller. Optionally, Agent selector may query active P4 program to include the already configured forwarding rules in N4 association response. Lastly, Agent Selector returns an “N4 Association Setup Response” which includes acceptance indication, node id, supported rules by P4 switch and agent N4, and already configured tunnel Id (TEID) or IP based forwarding rules in P4 switch.

FIG. 8B illustrates a forwarding rule update message sequence initiated by SMF. The mobile user or application based forwarding rules are changed by SMF units with “N4 Session Establishment, Modification or Termination Request” messages. Once the N4 association is established with the procedure in FIG. 8A, all other N4 messages are forwarded to agent N4. As N4 receives a forwarding rule update, it sends the required modification directives to the P4 Program Generator. P4 Program Generator prepares a new P4 program by adding new modifications to the lastly configured program and forwards to P4 switch. As P4 switch successfully implement the new P4 program, the success is reported to the SMF with “N4 Session Establishment, Modification or Termination Response”.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for the effective implementation of a system and method for a translator supporting multiple SDN APIs. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing or networking hardware.

1. A method as implemented in a network switch within a software defined network (SDN), the method comprising:
(a) receiving, from a controller in the SDN, a request to attach and control the network switch over a specific SDN protocol type among one or more SDN protocol types, the network switch supporting the one or more SDN protocol types, the network switch having a switching component having an associated programming language, the network switch storing, for a given SDN protocol type:
(1) an agent application, (2) an application programming interface (API), and (3) information in the agent application for communicating with the controller via the given SDN protocol type;
(b) activating a specific agent application corresponding to the specific SDN protocol type specified by the request;
(c) receiving one or more messages from the controller;
(d) translating messages received in (c) using the activated specific agent application from the specific SDN protocol type to the programming language associated with the switching component of the network switch; and
(e) programming the switching component according to translated messages in (d).

2. The method of claim 1, wherein the method further comprises the step of deactivating another agent application either prior to or right after the activating in step (b).

3. The method of claim 1, wherein the one or more SDN protocol types comprises any of the following: OpenFlow, N4 and P4.

4. The method of claim 1, wherein the programming language of the switching component of the network switch comprises any of the following: Verilog, Hardware Description Language (HDL), and P4.

5. The method of claim 1, wherein the switching component comprises any of the following: a fixed-function Application-Specific Integrated Circuit (ASIC), a directly programmable ASIC, a Protocol Independent Switch Architecture (PISA) chip, a P4-based hardware, a Field-Programmable Gate Array (FPGA), and an Open vSwitch.

6. The method of claim 1, wherein programming in (e) is performed by sending a program to the switching component of the network switch, the switching component being either a local component or a remote component.

7. The method of claim 1, wherein programming in (e) is performed by sending a message to the switching component of the network switch, the switching component being either a local component or a remote component.

8. A network switch within a software defined network (SDN), the network switch comprising:
at least one network interface card (NIC);
a memory;
a central processing unit (CPU) linked to the NIC and the memory, and
wherein the network switch: (a) receiving, from a controller in the SDN, a request to attach and control the network switch over a specific SDN protocol type among one or more SDN protocol types, the network switch supporting the one or more SDN protocol types, the network switch having a switching component having an associated programming language, the network switch storing in the memory, for a given SDN protocol type: (1) an agent application, (2) an application programming interface (API), and (3) information in the agent application for communicating with the controller via the given SDN protocol type; (b) activating a specific agent application corresponding to the specific SDN protocol type specified by the request; (c) receiving one or more messages over the NIC from the controller; (d) translating messages received in (c) using the activated specific agent application from the specific SDN protocol type to the programming language associated with the switching component of the network switch; and (e) programming the switching component according to translated messages in (d).

9. The network switch of claim 8, wherein the network switch further comprises: a local packet data forwarding component comprising either a generic or special purpose hardware or software, and a plurality of additional NICs to forward packet data traffic.

10. The network switch of claim 8, wherein the network switch deactivates another agent application either prior to or right after the activating in (b).

11. The network switch of claim 8, wherein the one or more SDN protocol types comprises any of the following: OpenFlow, N4 and P4.

12. The network switch of claim 8, wherein the programming language of the switching component of the network switch comprises any of the following: Verilog, Hardware Description Language (HDL), and P4.

13. The network switch of claim 8, wherein the switching component comprises any of the following: a fixed-function Application-Specific Integrated Circuit (ASIC), a directly programmable ASIC, a Protocol Independent Switch Architecture (PISA) chip, a P4-based hardware, a Field-Programmable Gate Array (FPGA), and an Open vSwitch.

14. The network switch of claim 8, wherein programming in (e) is performed by sending a program to the switching component of the network switch, the switching component being either a local component or a remote component.

15. The network switch of claim 8, wherein programming in (e) is performed by sending a message to the switching component of the network switch, the switching component being either a local component or a remote component.

16. An article of manufacture comprising non-transitory computer storage medium storing computer readable program code which, when executed by a processor implements a method as implemented in a network switch within a software defined network (SDN), the computer storage medium comprising:
(a) computer readable program code receiving, from a controller in the SDN, a request to attach and control the network switch over a specific SDN protocol type among one or more SDN protocol types, the network switch supporting the one or more SDN protocol types, the network switch having a switching component having an associated programming language, the network switch storing, for a given SDN protocol type: (1) an agent application, (2) an application programming interface (API), and (3) information in the agent application for communicating with the controller via the given SDN protocol type;
(b) computer readable program code activating a specific agent application corresponding to the specific SDN protocol type specified by the request;
(c) computer readable program code receiving one or more messages from the controller;
(d) computer readable program code translating messages received in
(c) using the activated specific agent application from the specific SDN protocol type to the programming language associated with the switching component of the network switch; and
(e) computer readable program code programming the switching component according to translated messages in (d).

17. The article of manufacture of claim 16, wherein the computer storage medium further comprises computer readable program code deactivating another agent application either prior to or right after the activating in step (b).

18. The article of manufacture of claim 16, wherein the one or more SDN protocol types comprises any of the following: OpenFlow, N4 and P4.

19. The article of manufacture of claim 16, wherein the programming language of the switching component of the network switch comprises any of the following: Verilog, Hardware Description Language (HDL), and P4.

20. The article of manufacture of claim 16, wherein the switching component comprises any of the following: a fixed-function Application-Specific Integrated Circuit (ASIC), a directly programmable ASIC, a Protocol Independent Switch Architecture (PISA) chip, a P4-based hardware, a Field-Programmable Gate Array (FPGA), and an Open vSwitch.
